(19) United States
(12) Patent Application Publication
(10) Pub. No.: US 2006/0039172 A1
(43) Pub. Date: Feb. 23, 2006

(54) Circuit to improve capacitor hold-up time in a converter circuit

(75) Inventor: Marco Soldano, El Segundo, CA (US)

Correspondence Address: OSTROLENK FABER GERB & SOFFEN, 1180 AVENUE OF THE AMERICAS, NEW YORK, NY, 100368403, US

(73) Assignee: International Rectifier Corporation

(21) Appl. No.: 11/209,600

(22) Filed: Aug. 23, 2005

Related U.S. Application Data
(60) Provisional application No. 60/603,813, filed on Aug. 23, 2004.

(51) Int. Cl. H02M 3/18

(52) U.S. Cl. 363/59

(57) ABSTRACT

A circuit for increasing the bulk capacitor hold-up time in a converter circuit wherein the converter circuit comprises an input circuit for providing a DC bus voltage and a DC bulk capacitor connected across the output of the input circuit, and further comprising an output DC to DC converter circuit having an input coupled to the DC bus and providing an output voltage, the circuit comprising a boost converter circuit having an input coupled across the DC bulk capacitor and having an output coupled to the input of the output DC to DC converter stage.

### CROSS-REFERENCE TO RELATED APPLICATIONS

The present application claims the benefit and priority of U.S. Provisional Application 60/603,813 filed Aug. 23, 2004 and entitled CIRCUIT TO IMPROVE CAPACITOR HOLD-UP TIME, the entire disclosure of which is incorporated by reference herein.

### BACKGROUND OF THE INVENTION

The present invention relates to circuits for improving the efficiency of energy storage in converter circuits. Capacitors are used in power supply circuits such as converter circuits to store energy. One of the main functions of the input bulk capacitor in an AC to DC system is to provide a certain amount of hold-up time when the AC line is failing. FIG. 1 shows a typical prior art circuit showing the AC line 10, an AC to DC input circuit 20 including a rectifier bridge and power factor correction circuit, a DC bus across which the DC bus capacitor or capacitors C are coupled to store energy and followed by a DC to DC output converter stage 30.

The capacitors C on the DC bus have a large volume and limit the maximum achievable power density. As shown, the prior art system usually comprises an AC to DC front end 20 and a DC to DC downstream converter 30. The DC to DC converter is designed to operate within a certain voltage input range as shown in FIG. 2. The bulk capacitors C are designed to maintain the input of the DC to DC converter within the specified range between VB_{MAX} and VB_{MIN} for the duration of the hold up time THU. At the end of that time, the voltage will fall out of the range and generally the DC to DC converter will shut down, leaving a certain amount of energy stored in the capacitor or capacitors C on the DC bus.

A circuit is known in the prior art from U.S. Pat. No. 6,504,497 which places a hold-up time extension circuit and auxiliary capacitor essentially in parallel with the DC bus capacitor to improve the hold-up time. However, this circuit adds additional components, i.e., requires an additional capacitor or capacitor bank and thus can potentially enlarge the capacitor bulk required in the circuit.

There is a need to improve the efficiency of the utilization of the energy stored in the bulk capacitor and thereby improve the hold-up time.

### SUMMARY OF THE INVENTION

It is an object of the present invention to provide a circuit which can be used in a converter circuit to improve the capacitor hold-up time, and in particular, which allows substantially all of the energy stored in the bulk capacitor to be used by the output DC to DC stage when the input AC waveform fails.

According to the invention, a boost circuit is provided at the output of the input rectifier stage (either PFC or plain input bridge) between the bulk capacitor and the DC to DC output stage. The boost maintains the input of the DC to DC output converter substantially constant while the bulk capacitor depletes. The duty cycle of the boost circuit can be controlled with a voltage control loop set for an output voltage slightly lower than the nominal output voltage of the AC to DC converter.

Other objects, features and advantages of the present invention will be apparent from the detailed description which follows.

### BRIEF DESCRIPTION OF THE DRAWING(S)

The invention will now be described in greater detail in the following detailed description with reference to the drawings in which:

FIG. 1 shows a prior art AC to DC converter;

FIG. 2 shows waveforms in the circuit of FIG. 1 when the input AC voltage fails;

FIG. 3 shows a block diagram of a circuit according to the present invention;

FIG. 3A shows another embodiment of a circuit according to the invention;

FIG. 4 shows waveforms for the circuits of FIGS. 3 and 3A; and

FIG. 5 shows an implementation of the cascade boost circuit of FIG. 3 and FIG. 3A.

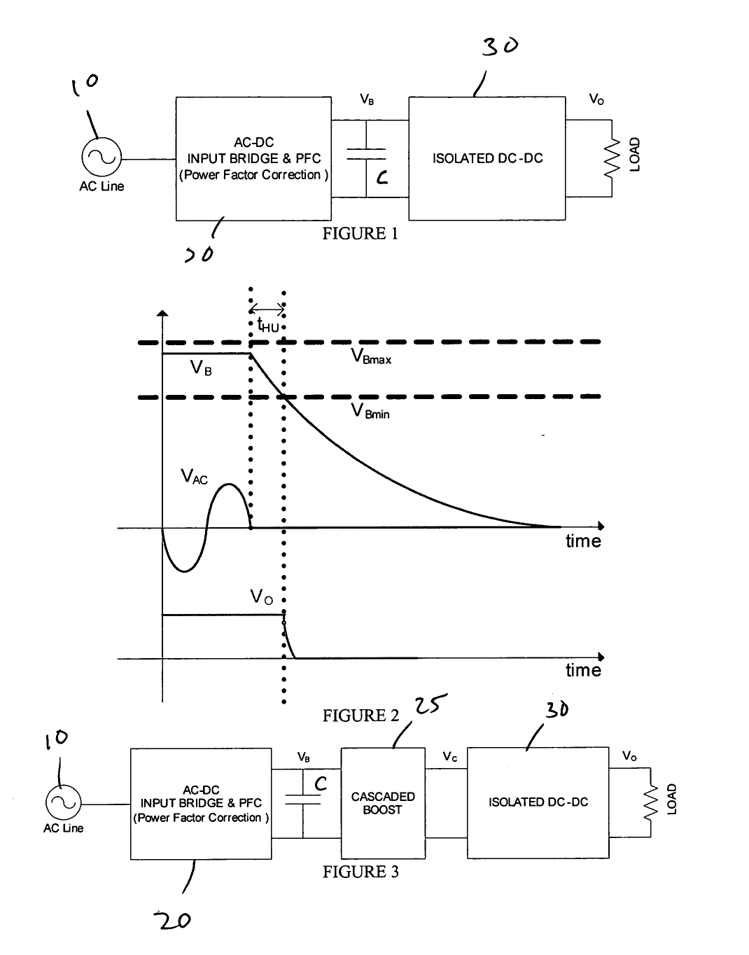

### DETAILED DESCRIPTION OF PREFERRED EMBODIMENTS OF THE INVENTION

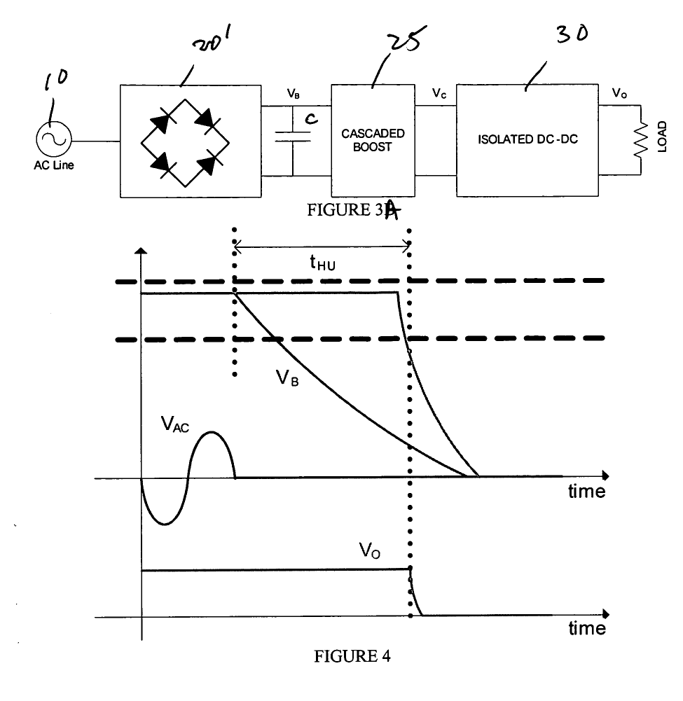

With reference now to the drawings, FIG. 3 shows a circuit according to the present invention. A cascaded boost stage 25 as shown in FIG. 4 is provided between the DC bulk capacitor C and the DC to DC converter 30 provided at the output. When the AC line fails, the voltage on the bulk capacitor C will start to fall. Because the duty cycle of the DC to DC converter 30 can get very large, up to 99%, the DC to DC converter 30 will continue to operate until the bulk capacitor C is substantially completely depleted.

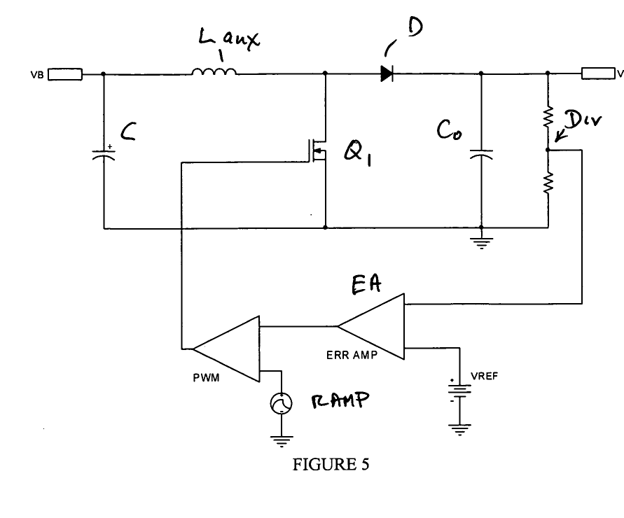

The duty cycle of the boost converter stage 25 can be controlled with a voltage control loop as shown in FIG. 5, known to those of skill in the art, set for an output voltage slightly lower than the nominal output voltage V0 of the entire AC to DC converter. As shown, a divider circuit DIV can be used to sense the output voltage V0. This is sensed by an error amplifier EA and compared to a reference voltage V_{REF}. The output of the error amplifier EA is coupled, in known manner to a PWM comparator (PWM) for comparison to an oscillating signal, typically a ramp signal, to produce the PWM signal to drive the boost converter switch MOSFET Q1. The other well known components of the boost converter circuit include the inductor Lₐᵤₓ, output capacitor C_{O} and the diode D. The diode D can comprise a synchronous device, i.e., another controlled MOSFET switch. The devices Q1 and D can be implemented in any suitable technology, for example in silicon or gallium nitride (GaN).

When the front end PFC converter should not be present, but only a simple bridge rectifier as shown in FIG. 3A by block 20′, the boost circuit output voltage can be set to the minimum operating voltage of the DC to DC output converter. By doing so the boost converter will only operate in case of AC line voltage failure, leading to higher system efficiency.

Compared to traditional systems where only part of the energy stored in the bulk capacitor is used for hold-up, according to the following equation.

FIG. 4 shows waveforms of the circuit, showing how THU is

$${E}_{bulk} = \frac{1}{2} {C}_{BULK} ( {V}_{max}^{2} - {V}_{min}^{2} ) ,$$

this method uses substantially the entire energy stored in the capacitor as follows:

$${E}_{bulk} = \frac{1}{2} {C}_{BULK} ( {V}^{2} )$$

improved and how substantially the entire energy in the bus capacitor C is used to improve the hold up time.

Assuming an AC to DC converter with an output voltage of 400 volts and a DC to DC converter stage with an input voltage range Vin=300 to 400 volts, using this invention would reduce the value of the hold-up capacitor to about 43.7% of the original value, leading to a significant reduction in the size of the capacitor and increasing the power density.

The additional boost stage will be required to work only for a limited amount of time. The hold-up time that is usually limited to a few milliseconds, therefore, will not require a large heat sink and can operate at high frequencies. This will in turn reduce the size of the inductor LAUX in the boost stage.

Although the present invention has been described in relation to particular embodiments thereof, many other variations and modifications and other uses will become apparent to those skilled in the art. Therefore the present invention should be limited not by the specific disclosure herein, but only by the appended claims.

What is claimed is:

1. A circuit for increasing the bulk capacitor hold-up time in a converter circuit wherein the converter circuit comprises an input circuit for providing a DC bus voltage and a DC bulk capacitor connected across the output of the input circuit, and further comprising an output DC to DC converter circuit having an input coupled to the DC bus and providing an output voltage, the circuit comprising:
a boost converter circuit having an input coupled across the DC bulk capacitor and having an output coupled to the input of the output DC to DC converter stage.

2. The circuit of claim 1, wherein the boost converter circuit comprises an inductor having a first end coupled to said DC bulk capacitor and having a second end coupled to a main current carrying terminal of a controlled switch, the controlled switch having a second main current carrying terminal coupled to a second terminal of said bulk capacitor, and further comprising a second switch coupled to a common connection of the first switch and the second end of the inductor, the second switch being coupled to an input of the output DC to DC converter circuit and further comprising an output capacitor coupled across the input of said output DC to DC converter circuit.

3. The circuit of claim 2, wherein the first switch comprises a semiconductor switch and the second switch comprises a rectifier diode.

4. The circuit of claim 3, wherein the first switch has a control electrode provided with a PWM signal whose duty cycle is controlled by a voltage control loop having an input coupled to the output of the DC to DC converter circuit.

5. The circuit of claim 4, wherein the voltage control loop has an output threshold voltage set slightly lower than the output voltage of the output DC to DC converter circuit.

6. The circuit of claim 4, wherein the boost converter circuit output voltage is set to a minimum operating voltage of the output DC to DC converter circuit.

7. The circuit of claim 5, wherein the input circuit comprises a rectifier circuit and power factor correction circuit.

8. The circuit of claim 6, wherein the input circuit comprises a rectifier circuit.
